(19) United States
(12) Patent Application Publication
(10) Pub. No.: US 2021/0301851 A1
(43) Pub. Date: Sep. 30, 2021

(54) FASTENING SYSTEM

(71) Applicant: DENSO International America, Inc., Southfield, MI (US)

(72) Inventors: Preston MOORE, Farmington Hills, MI (US); Grant HILBERT, Farmington Hills, MI (US)

(21) Appl. No.: 16/835,801

(22) Filed: Mar. 31, 2020

(51) Int. Cl. F16B 5/06

(52) U.S. Cl. CPC F16B 5/0664

(57) ABSTRACT

A fastening system includes a first connector and a second connector. The first connector has a protrusion, a first clip, and a first catch. The first clip and the first catch are offset from the protrusion. The second connector defines a slot, has a second clip, and has a second catch. The second clip and the second catch are offset from the slot. The slot is configured to receive the protrusion upon engagement between the first connector and the second connector. The first clip is biased into engagement with the second catch and the second clip is biased into engagement with the first catch upon engagement between the first connector and the second connector to secure the first connector to the second connector.

### TECHNICAL FIELD

The present disclosure relates to fastening systems that may be utilized to connect two or more subcomponents of a system to each other.

### BACKGROUND

Fastening systems may be utilized to connect two or more subcomponents of a system to each other.

### SUMMARY

A fastening system includes a male connector and a female connector. The male connector has a guide pin, a first clip, and a first catch. The guide pin extends in a first direction. The first clip and the first catch are offset from the guide pin in a second direction that is substantially perpendicular to the first direction. The first clip is biased radially relative to a first axis that is substantially parallel to the second direction. The female connector defines a slot, has a second clip, and has a second catch. The slot extends in the first direction. The second clip and the second catch are offset from the slot in the second direction. The second clip is biased radially relative to a second axis that is substantially parallel to the second direction. The slot is configured to receive the guide pin upon engagement between the male connector and the female connector in the first direction. The first clip is biased into engagement with the second catch and the second clip is biased into engagement with the first catch to secure the male connector to the female connector.

A fastening system includes a first connector and a second connector. The first connector has a protrusion, a first clip, and a first catch. The first clip and the first catch are offset from the protrusion. The second connector defines a slot, has a second clip, and has a second catch. The second clip and the second catch are offset from the slot. The slot is configured to receive the protrusion upon engagement between the first connector and the second connector. The first clip is biased into engagement with the second catch and the second clip is biased into engagement with the first catch upon engagement between the first connector and the second connector to secure the first connector to the second connector.

A fastening system includes a male connector and a female connector. The male connector has a first frame, a guide pin extending from the first frame, a first clip extending laterally from the first frame, and a first catch extending upward from the first frame. The first clip and the first catch are offset from the guide pin. The female connector has a second frame defining a slot, a second clip extending laterally from the second frame, and a second catch extending upward from the second frame. The second clip and the second catch are offset from the slot. The slot is configured to receive the guide pin upon engagement between the male connector and the female connector. The first clip is biased into engagement with the second catch and the second clip is biased into engagement with the first catch upon engagement between the male connector and the female connector to secure the male connector to the female connector.

### BRIEF DESCRIPTION OF THE DRAWINGS

FIG. 1 is an exploded isometric view of a first embodiment of a fastening system that includes a first connector and second connector;

FIG. 2 is an isometric view of the first embodiment of the fastening system illustrating a connected condition between the first and second connectors;

FIG. 3 is an exploded isometric view of a second embodiment of a fastening system that includes a first connector and second connector;

FIG. 4 is an isometric view of the second embodiment of the fastening system illustrating a connected condition between the first and second connectors;

FIG. 5 is an exploded isometric view of a third embodiment of a fastening system that includes a first connector and second connector;

FIG. 6 is an isometric view of the third embodiment of the fastening system illustrating a connected condition between the first and second connectors;

FIG. 7 is an exploded isometric view of a fourth embodiment of a fastening system that includes a first connector and second connector;

FIG. 8 is an isometric view of the fourth embodiment of the fastening system illustrating a connected condition between the first and second connectors;

FIG. 9 is an exploded isometric view of a fifth embodiment of a fastening system that includes a first connector and second connector;

FIG. 10 is an isometric view of the fifth embodiment of the fastening system illustrating a connected condition between the first and second connectors; and

FIG. 11 is an isometric view of a sixth embodiment of a fastening system illustrating a connected condition between first and second connectors of the sixth embodiment of the fastening system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

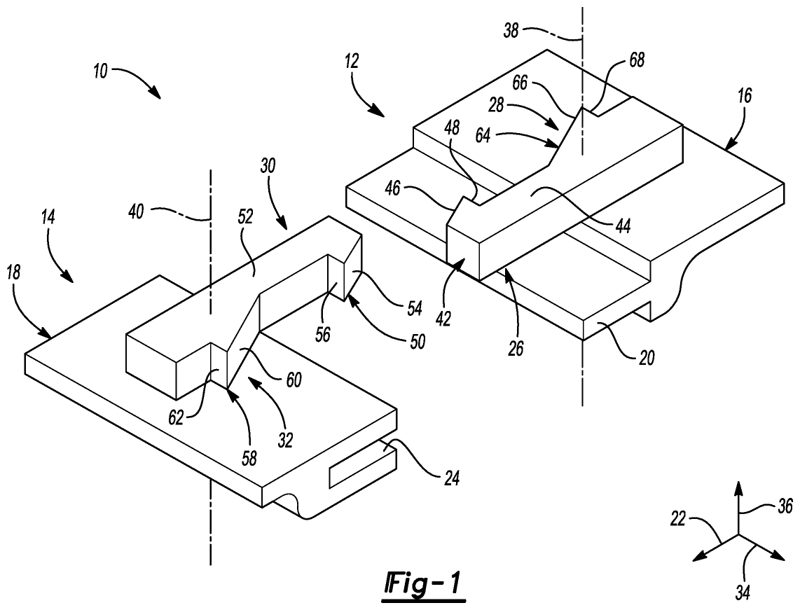

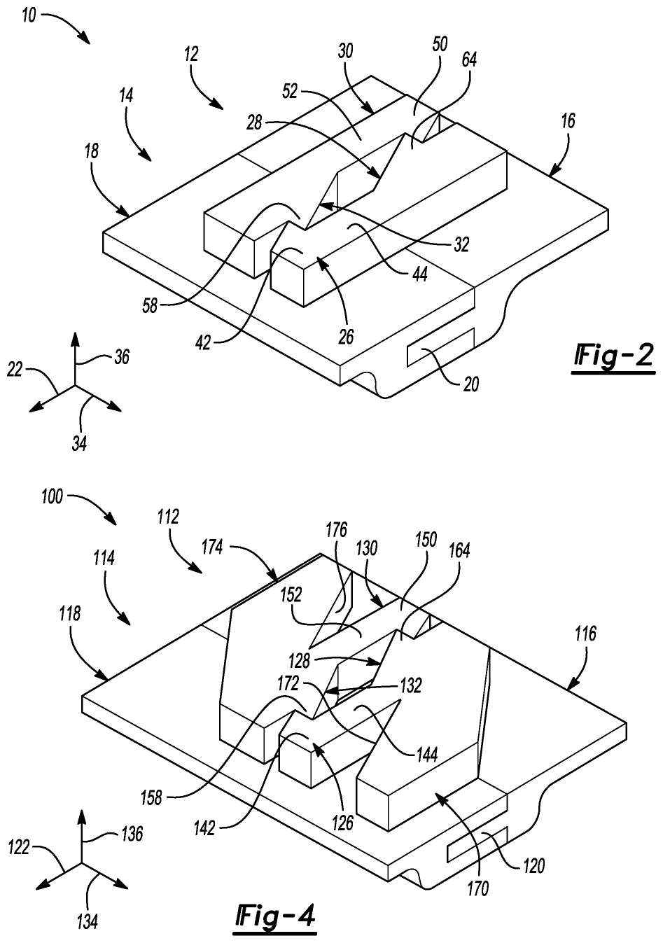

Referring to FIGS. 1 and 2, a first embodiment of a fastening system 10 is illustrated. The fastening system 10 includes a male connector 12 and a female connector 14. The male connector 12 and the female connector 14 may be referred to as the first and second connectors, respectively, or vice versa. The male connector 12 includes a first frame 16 and the female connector 14 includes a second frame 18. The male connector 12 includes a protrusion or guide pin 20 that extends in a first direction 22. More specifically, the protrusion or guide pin 20 may extend from the first frame 16 in the first direction 22. The female connector 14 defines a slot 24 that also extends in the first direction 22. More specifically, the second frame 18 defines the slot 24. The slot 24 is configured to receive the guide pin 20 upon engagement between the male connector 12 and the female connector 14 in the first direction 22.

The male connector 12 includes a first clip 26 and a first catch 28. The female connector 14 includes a second clip 30 and a second catch 32. The first direction 22 and a second direction 34 that is transverse to the first direction 22 form a connection plane. The first direction 22 and the second direction 34 may be substantially perpendicular relative to each other. Substantially perpendicular may refer to any incremental value that ranges between 80° and 100°. The connection plane is the plane upon which the male connector 12 engages the female connector 14. The first clip 26 and the first catch 28 are offset from the guide pin 20 in a third direction 36. The third direction 36 may be substantially perpendicular to the first direction 22, the second direction 34, and the connection plane. Substantially perpendicular may refer to any incremental value that ranges between 80° and 100°. The second clip 30 and the second catch 32 are offset from the slot 24 in the third direction 36.

The first clip 26 and the first catch 28 extend upward from the first frame 16. The first clip 26 also extends laterally outward from the first frame 16. Extending laterally outward from the first frame 16 may refer to extending outward from the first frame 16 in any direction defined on the connection plane. However, extending laterally outward from the first frame 16 may specifically refer to extending outward from the first frame 16 in the first direction 22. The second clip 30 and the second catch 32 extend upward from second frame 18. The second clip 30 also extends laterally outward from the second frame 18. Extending laterally outward from the second frame 18 may refer to extending outward from the second frame 18 in any direction defined on the connection plane. However, extending laterally outward from the second frame 18 may specifically refer to extending outward from the second frame 18 in the first direction 22.

The first clip 26 is biased radially relative to a first axis 38 that is substantially parallel to the third direction 36 and substantially perpendicular to the connection plane. Substantially perpendicular may refer to any incremental value that ranges between 80° and 100° and substantially parallel may refer to any incremental value that ranges between exactly parallel and 10° from exactly parallel. The first clip 26 is configured to deflect and rotate about the first axis 38 along a plane that is substantially parallel to the connection plane during engagement between the male connector 12 and the female connector 14. Substantially parallel may refer to any incremental value that ranges between exactly parallel and 10° from exactly parallel. The second clip 30 is biased radially relative to a second axis 40 that is substantially parallel to the third direction 36 and substantially perpendicular to the connection plane. Substantially perpendicular may refer to any incremental value that ranges between 80° and 100° and substantially parallel may refer to any incremental value that ranges between exactly parallel and 10° from exactly parallel. The second clip 30 is configured to deflect and rotate about the second axis 40 along a plane that is substantially parallel to the connection plane during engagement between the male connector 12 and the female connector 14. Substantially parallel may refer that any incremental value that ranges between exactly parallel and 10° from exactly parallel. Upon engagement between the male connector 12 and the female connector 14, the first clip 26 is biased into engagement with the second catch 32 and the second clip 30 is biased into engagement with the first catch 28 to secure the male connector 12 to the female connector 14.

The first clip 26 includes a first tapered protrusion 42 and a first biasing element 44. The first tapered protrusion 42 is secured to the first catch 28 via the first biasing element 44. The first tapered protrusion 42 has a first tapered surface 46 that terminates at a first edge surface 48. The second clip 30 includes a second tapered protrusion 50 and a second biasing element 52. The second tapered protrusion 50 is secured to the second catch 32 via the second biasing element 52. The second tapered protrusion 50 has a second tapered surface 54 that terminates at a second edge surface 56.

The second catch 32 includes a third tapered protrusion 58 having a third tapered surface 60 that terminates at a third edge surface 62. The first tapered surface 46 is configured to engage the third tapered surface 60 such that the first tapered protrusion 42 deflects via the first biasing element 44 about the first axis 38 during engagement between the male connector 12 and the female connector 14. The first edge surface 48 is configured to engage the third edge surface 62 upon full engagement between the male connector 12 and the female connector 14 to secure the position of the male connector 12 relative to the female connector 14 and to prevent disengagement of the male connector 12 from the female connector 14, particularly in the first direction 22.

The first catch 28 includes a fourth tapered protrusion 64 having a fourth tapered surface 66 that terminates at a fourth edge surface 68. The fourth tapered surface 66 is configured to engage the second tapered surface 54 such that the second tapered protrusion 50 deflects via the second biasing element 52 about the second axis 40 during engagement between the male connector 12 and the female connector 14. The second edge surface 56 is configured to engage the fourth edge surface 68 upon full engagement between the male connector 12 and the female connector 14 to secure the position of the male connector 12 relative to the female connector 14 and to prevent disengagement of the male connector 12 from the female connector 14, particularly in the first direction 22.

Disengagement between the male connector 12 and the female connector 14 may be accomplished via deflecting the first tapered protrusion 42 such that the first edge surface 48 disengages and clears the third edge surface 62 and via deflecting the second tapered protrusion 50 such that the second edge surface 56 disengages and clears the fourth edge surface 68. The first edge surface 48 clearing the third edge surface 62 may refer to a lack of interference between the first edge surface 48 and the third edge surface 62 in the first direction 22, and the second edge surface 56 clearing the fourth edge surface 68 may refer to a lack of interference between the second edge surface 56 and the fourth edge surface 68 in the first direction 22 such that the male connector 12 and the female connector 14 may be disengaged in the first direction 22. Deflection of the first tapered protrusion 42 and the second tapered protrusion 50 may be accomplished via inserting a tool (such as a flat head screw driver) between the first clip 26 and the second clip 30, followed by turning the tool so that it engages and deflects both the first tapered protrusion 42 and the second tapered protrusion 50 via the first biasing element 44 and second biasing element 52, respectively.

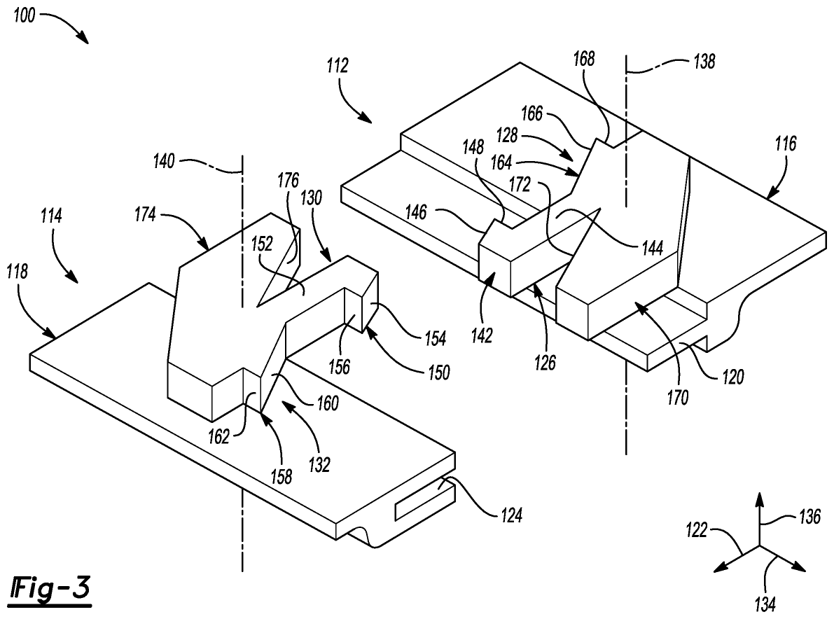

Referring to FIGS. 3 and 4, a second embodiment of a fastening system 100 is illustrated. The fastening system 100 includes a male connector 112 and a female connector 114. The male connector 112 and the female connector 114 may be referred to as the first and second connectors, respectively, or vice versa. The male connector 112 includes a first frame 116 and the female connector 114 includes a second frame 118. The male connector 112 includes a protrusion or guide pin 120 that extends in a first direction 122. More specifically, the protrusion or guide pin 120 may extend from the first frame 16 in the first direction 122. The female connector 114 defines a slot 124 that also extends in the first direction 122. More specifically, the second frame 118 defines the slot 124. The slot 124 is configured to receive the guide pin 120 upon engagement between the male connector 112 and the female connector 114 in the first direction 122.

The male connector 112 includes a first clip 126 and a first catch 128. The female connector 114 includes a second clip 130 and a second catch 132. The first direction 122 and a second direction 134 that is transverse to the first direction 122 form a connection plane. The first direction 122 and the second direction 134 may be substantially perpendicular relative to each other. Substantially perpendicular may refer to any incremental value that ranges between 80° and 100°. The connection plane is the plane upon which the male connector 112 engages the female connector 114. The first clip 126 and the first catch 128 are offset from the guide pin 120 in a third direction 136. The third direction 136 may be substantially perpendicular to the first direction 122, the second direction 134, and the connection plane. Substantially perpendicular may refer to any incremental value that ranges between 80° and 100°. The second clip 130 and the second catch 132 are offset from the slot 124 in the third direction 136.

The first clip 126 and the first catch 128 extend upward from the first frame 116. The first clip 126 also extends laterally outward from the first frame 116. Extending laterally outward from the first frame 116 may refer to extending outward from the first frame 116 in any direction defined on the connection plane. However, extending laterally outward from the first frame 116 may specifically refer to extending outward from the first frame 116 in the first direction 122. The second clip 130 and the second catch 132 extend upward from second frame 118. The second clip 130 also extends laterally outward from the second frame 118. Extending laterally outward from the second frame 118 may refer to extending outward from the second frame 118 in any direction defined on the connection plane. However, extending laterally outward from the second frame 118 may specifically refer to extending outward from the second frame 118 in the first direction 122.

The first clip 126 is biased radially relative to a first axis 138 that is substantially parallel to the third direction 136 and substantially perpendicular to the connection plane. Substantially perpendicular may refer to any incremental value that ranges between 80° and 100° and substantially parallel may refer to any incremental value that ranges between exactly parallel and 10° from exactly parallel. The first clip 126 is configured to deflect and rotate about the first axis 138 along a plane that is substantially parallel to the connection plane during engagement between the male connector 112 and the female connector 114. Substantially parallel may refer to any incremental value that ranges between exactly parallel and 10° from exactly parallel. The second clip 130 is biased radially relative to a second axis 140 that is substantially parallel to the third direction 136 and substantially perpendicular to the connection plane. Substantially perpendicular may refer to any incremental value that ranges between 80° and 100° and substantially parallel may refer to any incremental value that ranges between exactly parallel and 10° from exactly parallel. The second clip 130 is configured to deflect and rotate about the second axis 140 along a plane that is substantially parallel to the connection plane during engagement between the male connector 112 and the female connector 114. Substantially parallel may refer that any incremental value that ranges between exactly parallel and 10° from exactly parallel. Upon engagement between the male connector 112 and the female connector 114, the first clip 126 is biased into engagement with the second catch 132 and the second clip 130 is biased into engagement with the first catch 128 to secure the male connector 112 to the female connector 114.

The first clip 126 includes a first tapered protrusion 142 and a first biasing element 144. The first tapered protrusion 142 is secured to the first catch 128 via the first biasing element 144. The first tapered protrusion 142 has a first tapered surface 146 that terminates at a first edge surface 148. The second clip 130 includes a second tapered protrusion 150 and a second biasing element 152. The second tapered protrusion 150 is secured to the second catch 132 via the second biasing element 152. The second tapered protrusion 150 has a second tapered surface 154 that terminates at a second edge surface 156.

The second catch 132 includes a third tapered protrusion 158 having a third tapered surface 160 that terminates at a third edge surface 162. The first tapered surface 146 is configured to engage the third tapered surface 160 such that the first tapered protrusion 142 deflects via the first biasing element 144 about the first axis 138 during engagement between the male connector 112 and the female connector 114. The first edge surface 148 is configured to engage the third edge surface 162 upon full engagement between the male connector 112 and the female connector 114 to secure the position of the male connector 112 relative to the female connector 114 and to prevent disengagement of the male connector 112 from the female connector 114, particularly in the first direction 122.

The first catch 128 includes a fourth tapered protrusion 164 having a fourth tapered surface 166 that terminates at a fourth edge surface 168. The fourth tapered surface 166 is configured to engage the second tapered surface 154 such that the second tapered protrusion 150 deflects via the second biasing element 152 about the second axis 140 during engagement between the male connector 112 and the female connector 114. The second edge surface 156 is configured to engage the fourth edge surface 168 upon full engagement between the male connector 112 and the female connector 114 to secure the position of the male connector 112 relative to the female connector 114 and to prevent disengagement of the male connector 112 from the female connector 114, particularly in the first direction 122.

Disengagement between the male connector 112 and the female connector 114 may be accomplished via deflecting the first tapered protrusion 142 such that the first edge surface 148 disengages and clears the third edge surface 162 and via deflecting the second tapered protrusion 150 such that the second edge surface 156 disengages and clears the fourth edge surface 168. The first edge surface 148 clearing the third edge surface 162 may refer to a lack of interference between the first edge surface 148 and the third edge surface 162 in the first direction 122, and the second edge surface 156 clearing the fourth edge surface 168 may refer to a lack of interference between the second edge surface 156 and the fourth edge surface 168 in the first direction 122 such that the male connector 112 and the female connector 114 may be disengaged in the first direction 122. Deflection of the first tapered protrusion 142 and the second tapered protrusion 150 may be accomplished via inserting a tool (such as a flat head screw driver) between the first clip 126 and the second clip 130, followed by turning the tool so that it engages and deflects both the first tapered protrusion 142 and the second tapered protrusion 150 via the first biasing element 144 and second biasing element 152, respectively.

The male connector 112 includes a first backstop 170 that extends upward from the first frame 116 and laterally outward from the first frame 116. The first backstop 170 limits deflection of the first tapered protrusion 142 and the first biasing element 144. More specifically, the first backstop 170 includes a tapered surface 172 that limits deflection of the first tapered protrusion 142 and the first biasing element 144 along the connection plane to prevent the first biasing element 144 from over-deflecting, which could result in plastic deformation or fracturing of the first biasing element 144. The first backstop 170 may also act as a shield or guard that protects the first clip 126, including the first tapered protrusion 142 and the first biasing element 144, from external forces or objects that could potentially cause damage to the first clip 126.

The female connector 114 includes a second backstop 174 that extends upward from the second frame 118 and laterally outward from the second frame 118. The second backstop 174 limits deflection of the second tapered protrusion 150 and the second biasing element 152. More specifically, the second backstop 174 includes a tapered surface 176 that limits deflection of the second tapered protrusion 150 and the second biasing element 152 along the connection plane to prevent the second biasing element 152 from over-deflecting, which could result in plastic deformation or fracturing of the second biasing element 152. The second backstop 174 may also act as a shield or guard that protects the second clip 130, including the second tapered protrusion 150 and the second biasing element 152, from external forces or objects that could potentially cause damage to the second clip 130.

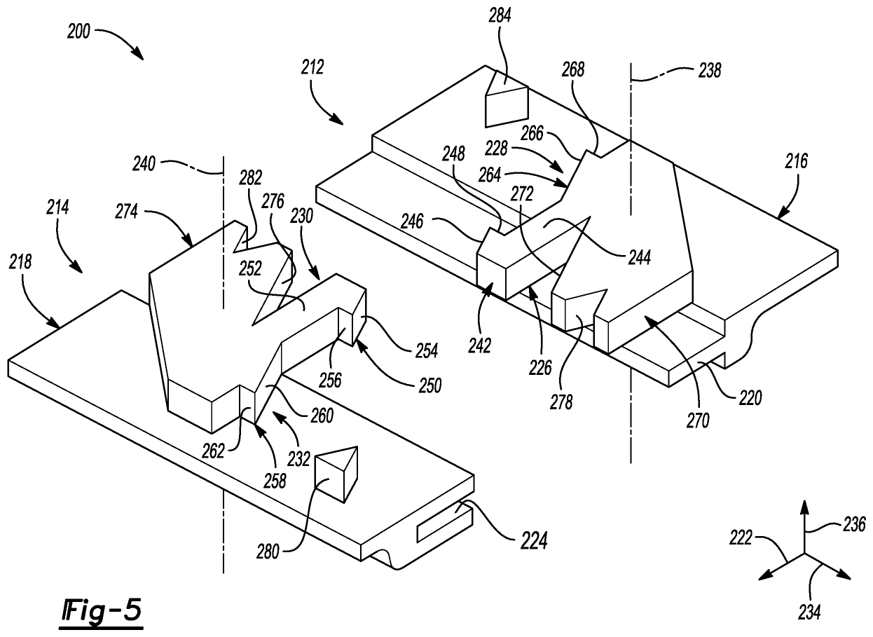

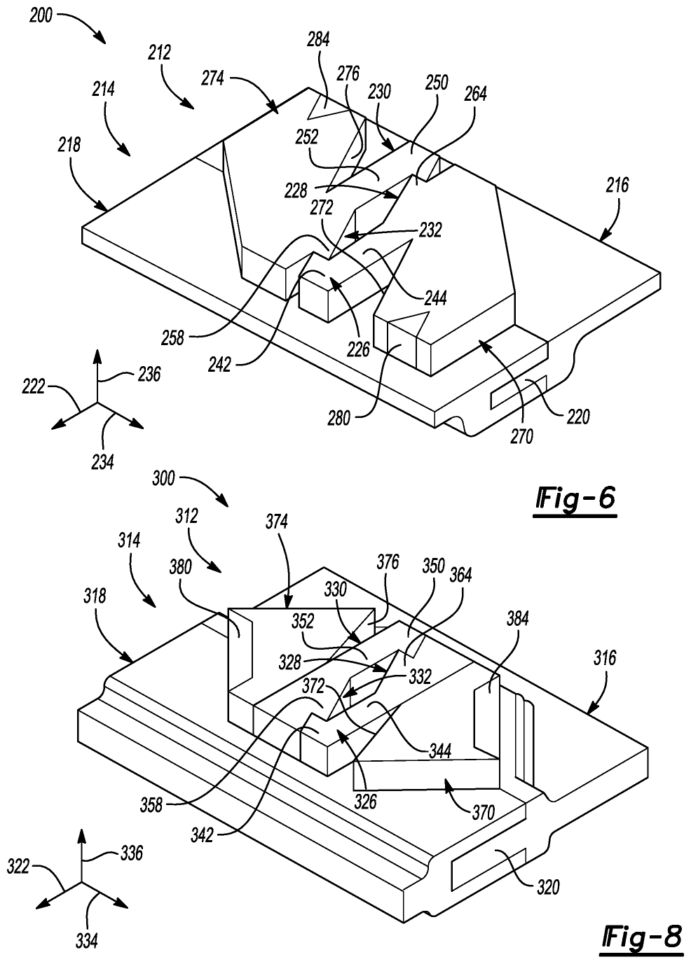

Referring to FIGS. 5 and 6, a third embodiment of a fastening system 200 is illustrated. The fastening system 200 includes a male connector 212 and a female connector 214. The male connector 212 and the female connector 214 may be referred to as the first and second connectors, respectively, or vice versa. The male connector 212 includes a first frame 216 and the female connector 214 includes a second frame 218. The male connector 212 includes a protrusion or guide pin 220 that extends in a first direction 222. More specifically, the protrusion or guide pin 220 may extend from the first frame 216 in the first direction 222. The female connector 214 defines a slot 224 that also extends in the first direction 222. More specifically, the second frame 218 defines the slot 224. The slot 224 is configured to receive the guide pin 220 upon engagement between the male connector 212 and the female connector 214 in the first direction 222.

The male connector 212 includes a first clip 226 and a first catch 228. The female connector 214 includes a second clip 230 and a second catch 232. The first direction 222 and a second direction 234 that is transverse to the first direction 222 form a connection plane. The first direction 222 and the second direction 234 may be substantially perpendicular relative to each other. Substantially perpendicular may refer to any incremental value that ranges between 80° and 100°. The connection plane is the plane upon which the male connector 212 engages the female connector 214. The first clip 226 and the first catch 228 are offset from the guide pin 220 in a third direction 236. The third direction 236 may be substantially perpendicular to the first direction 222, the second direction 234, and the connection plane. Substantially perpendicular may refer to any incremental value that ranges between 80° and 100°. The second clip 230 and the second catch 232 are offset from the slot 224 in the third direction 236.

The first clip 226 and the first catch 228 extend upward from the first frame 216. The first clip 226 also extends laterally outward from the first frame 216. Extending laterally outward from the first frame 216 may refer to extending outward from the first frame 216 in any direction defined on the connection plane. However, extending laterally outward from the first frame 216 may specifically refer to extending outward from the first frame 216 in the first direction 222. The second clip 230 and the second catch 232 extend upward from second frame 218. The second clip 230 also extends laterally outward from the second frame 218. Extending laterally outward from the second frame 218 may refer to extending outward from the second frame 218 in any direction defined on the connection plane. However, extending laterally outward from the second frame 218 may specifically refer to extending outward from the second frame 218 in the first direction 222.

The first clip 226 is biased radially relative to a first axis 238 that is substantially parallel to the third direction 236 and substantially perpendicular to the connection plane. Substantially perpendicular may refer to any incremental value that ranges between 80° and 100° and substantially parallel may refer to any incremental value that ranges between exactly parallel and 10° from exactly parallel. The first clip 226 is configured to deflect and rotate about the first axis 238 along a plane that is substantially parallel to the connection plane during engagement between the male connector 212 and the female connector 214. Substantially parallel may refer to any incremental value that ranges between exactly parallel and 10° from exactly parallel. The second clip 230 is biased radially relative to a second axis 240 that is substantially parallel to the third direction 236 and substantially perpendicular to the connection plane. Substantially perpendicular may refer to any incremental value that ranges between 80° and 100° and substantially parallel may refer to any incremental value that ranges between exactly parallel and 10° from exactly parallel. The second clip 230 is configured to deflect and rotate about the second axis 240 along a plane that is substantially parallel to the connection plane during engagement between the male connector 212 and the female connector 214. Substantially parallel may refer that any incremental value that ranges between exactly parallel and 10° from exactly parallel. Upon engagement between the male connector 212 and the female connector 214, the first clip 226 is biased into engagement with the second catch 232 and the second clip 230 is biased into engagement with the first catch 228 to secure the male connector 212 to the female connector 214.

The first clip 226 includes a first tapered protrusion 242 and a first biasing element 244. The first tapered protrusion 242 is secured to the first catch 228 via the first biasing element 244. The first tapered protrusion 242 has a first tapered surface 246 that terminates at a first edge surface 248. The second clip 230 includes a second tapered protrusion 250 and a second biasing element 252. The second tapered protrusion 250 is secured to the second catch 232 via the second biasing element 252. The second tapered protrusion 250 has a second tapered surface 254 that terminates at a second edge surface 256.

The second catch 232 includes a third tapered protrusion 258 having a third tapered surface 260 that terminates at a third edge surface 262. The first tapered surface 246 is configured to engage the third tapered surface 260 such that the first tapered protrusion 242 deflects via the first biasing element 244 about the first axis 238 during engagement between the male connector 212 and the female connector 214. The first edge surface 248 is configured to engage the third edge surface 262 upon full engagement between the male connector 212 and the female connector 214 to secure the position of the male connector 212 relative to the female connector 214 and to prevent disengagement of the male connector 212 from the female connector 214, particularly in the first direction 222.

The first catch 228 includes a fourth tapered protrusion 264 having a fourth tapered surface 266 that terminates at a fourth edge surface 268. The fourth tapered surface 266 is configured to engage the second tapered surface 254 such that the second tapered protrusion 250 deflects via the second biasing element 252 about the second axis 240 during engagement between the male connector 212 and the female connector 214. The second edge surface 256 is configured to engage the fourth edge surface 268 upon full engagement between the male connector 212 and the female connector 214 to secure the position of the male connector 212 relative to the female connector 214 and to prevent disengagement of the male connector 212 from the female connector 214, particularly in the first direction 222.

Disengagement between the male connector 212 and the female connector 214 may be accomplished via deflecting the first tapered protrusion 242 such that the first edge surface 248 disengages and clears the third edge surface 262 and via deflecting the second tapered protrusion 250 such that the second edge surface 256 disengages and clears the fourth edge surface 268. The first edge surface 248 clearing the third edge surface 262 may refer to a lack of interference between the first edge surface 248 and the third edge surface 262 in the first direction 222, and the second edge surface 256 clearing the fourth edge surface 268 may refer to a lack of interference between the second edge surface 256 and the fourth edge surface 268 in the first direction 222 such that the male connector 212 and the female connector 214 may be disengaged in the first direction 222. Deflection of the first tapered protrusion 242 and the second tapered protrusion 250 may be accomplished via inserting a tool (such as a flat head screw driver) between the first clip 226 and the second clip 230, followed by turning the tool so that it engages and deflects both the first tapered protrusion 242 and the second tapered protrusion 250 via the first biasing element 244 and second biasing element 252, respectively.

The male connector 212 includes a first backstop 270 that extends upward from the first frame 216 and laterally outward from the first frame 216. The first backstop 270 limits deflection of the first tapered protrusion 242 and the first biasing element 244. More specifically, the first backstop 270 includes a tapered surface 272 that limits deflection of the first tapered protrusion 242 and the first biasing element 244 along the connection plane to prevent the first biasing element 244 from over-deflecting, which could result in plastic deformation or fracturing of the first biasing element 244. The first backstop 270 may also act as a shield or guard that protects the first clip 226, including the first tapered protrusion 242 and the first biasing element 244, from external forces or objects that could potentially cause damage to the first clip 226.

The female connector 214 includes a second backstop 274 that extends upward from the second frame 218 and laterally outward from the second frame 218. The second backstop 274 limits deflection of the second tapered protrusion 250 and the second biasing element 252. More specifically, the second backstop 274 includes a tapered surface 276 that limits deflection of the second tapered protrusion 250 and the second biasing element 252 along the connection plane to prevent the second biasing element 252 from over-deflecting, which could result in plastic deformation or fracturing of the second biasing element 252. The second backstop 274 may also act as a shield or guard that protects the second clip 230, including the second tapered protrusion 250 and the second biasing element 252, from external forces or objects that could potentially cause damage to the second clip 230.

The male connector 212 defines a first keyed slot 278 and the female connector 214 includes a first keyed protrusion 280. The first keyed protrusion 280 is configured to engage the male connector 212 within the first keyed slot 278 to prevent movement between the male connector 212 and the female connector 214 in a direction (e.g., the second direction 234) that is transverse to a direction of engagement between the male connector 212 and the female connector 214 (e.g., the first direction 222). The engagement between the first keyed protrusion 280 and the male connector 212 within the first keyed slot 278 is also configured to absorb any shearing forces that may be experienced by the either the male connector 212 or the female connector 214.

In the third embodiment of the fastening system 200, the first keyed slot 278 is defined by the first backstop 270 and the first keyed protrusion 280 extends upward from the second frame 218. It should be understood, however, that the first keyed slot 278 and the first keyed protrusion 280 may be positioned at any location on the fastening system 200. Furthermore, it should be understood that the shapes of the first keyed protrusion 280 and the first keyed slot 278 depicted in FIGS. 5 and 6 should not be construed as limiting. The first keyed protrusion 280 and the first keyed slot 278 may have any shape as long the engagement between the first keyed protrusion 280 and the first keyed slot 278 is configured to absorb shearing forces and to prevent movement between the male connector 212 and the female connector 214 in a direction that is transverse to a direction of engagement between the male connector 212 and the female connector 214.

The female connector 214 defines a second keyed slot 282 and the male connector 212 includes a second keyed protrusion 284. The second keyed protrusion 284 is configured to engage the female connector 214 within the second keyed slot 282 to prevent movement between the male connector 212 and the female connector 214 in a direction (e.g., the second direction 234) that is transverse to a direction of engagement between the male connector 212 and the female connector 214 (e.g., the first direction 222). The engagement between the second keyed protrusion 284 and the female connector 214 within the second keyed slot 282 is also configured to absorb any shearing forces that may be experienced by the either the male connector 212 or the female connector 214.

In the third embodiment of the fastening system 200, the second keyed slot 282 is defined by the second backstop 274 and the second keyed protrusion 284 extends upward from the first frame 216. It should be understood, however, that the second keyed slot 282 and the second keyed protrusion 284 may be positioned at any location on the fastening system 200. Furthermore, it should be understood that the shapes of the second keyed protrusion 284 and the second keyed slot 282 depicted in FIGS. 5 and 6 should not be construed as limiting. The second keyed protrusion 284 and the second keyed slot 282 may have any shape as long the engagement between the second keyed protrusion 284 and the second keyed slot 282 is configured to absorb shearing forces and to prevent movement between the male connector 212 and the female connector 214 in a direction that is transverse to a direction of engagement between the male connector 212 and the female connector 214.

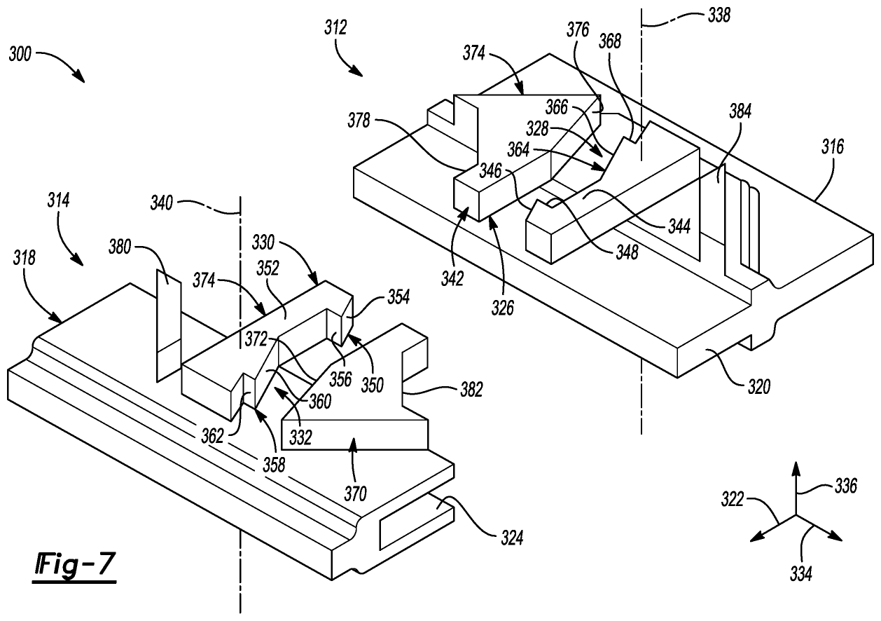

Referring to FIGS. 7 and 8, a fourth embodiment of a fastening system 300 is illustrated. The fastening system 300 includes a male connector 312 and a female connector 314. The male connector 312 and the female connector 314 may be referred to as the first and second connectors, respectively, or vice versa. The male connector 312 includes a first frame 316 and the female connector 314 includes a second frame 318. The male connector 312 includes a protrusion or guide pin 320 that extends in a first direction 322. More specifically, the protrusion or guide pin 320 may extend from the first frame 316 in the first direction 322. The female connector 314 defines a slot 324 that also extends in the first direction 322. More specifically, the second frame 318 defines the slot 324. The slot 324 is configured to receive the guide pin 320 upon engagement between the male connector 312 and the female connector 314 in the first direction 322.

The male connector 312 includes a first clip 326 and a first catch 328. The female connector 314 includes a second clip 330 and a second catch 332. The first direction 322 and a second direction 334 that is transverse to the first direction 322 form a connection plane. The first direction 322 and the second direction 334 may be substantially perpendicular relative to each other. Substantially perpendicular may refer to any incremental value that ranges between 80° and 100°. The connection plane is the plane upon which the male connector 312 engages the female connector 314. The first clip 326 and the first catch 328 are offset from the guide pin 320 in a third direction 336. The third direction 336 may be substantially perpendicular to the first direction 322, the second direction 334, and the connection plane. Substantially perpendicular may refer to any incremental value that ranges between 80° and 100°. The second clip 330 and the second catch 332 are offset from the slot 324 in the third direction 336.

The first clip 326 and the first catch 328 extend upward from the first frame 316. The first clip 326 also extends laterally outward from the first frame 316. Extending laterally outward from the first frame 316 may refer to extending outward from the first frame 316 in any direction defined on the connection plane. However, extending laterally outward from the first frame 316 may specifically refer to extending outward from the first frame 316 in the first direction 322. The second clip 330 and the second catch 332 extend upward from second frame 318. The second clip 330 also extends laterally outward from the second frame 318. Extending laterally outward from the second frame 318 may refer to extending outward from the second frame 318 in any direction defined on the connection plane. However, extending laterally outward from the second frame 318 may specifically refer to extending outward from the second frame 318 in the first direction 322.

The first clip 326 is biased radially relative to a first axis 338 that is substantially parallel to the third direction 336 and substantially perpendicular to the connection plane. Substantially perpendicular may refer to any incremental value that ranges between 80° and 100° and substantially parallel may refer to any incremental value that ranges between exactly parallel and 10° from exactly parallel. The first clip 326 is configured to deflect and rotate about the first axis 338 along a plane that is substantially parallel to the connection plane during engagement between the male connector 312 and the female connector 314. Substantially parallel may refer to any incremental value that ranges between exactly parallel and 10° from exactly parallel. The second clip 330 is biased radially relative to a second axis 340 that is substantially parallel to the third direction 336 and substantially perpendicular to the connection plane. Substantially perpendicular may refer to any incremental value that ranges between 80° and 100° and substantially parallel may refer to any incremental value that ranges between exactly parallel and 10° from exactly parallel. The second clip 330 is configured to deflect and rotate about the second axis 340 along a plane that is substantially parallel to the connection plane during engagement between the male connector 312 and the female connector 314. Substantially parallel may refer that any incremental value that ranges between exactly parallel and 10° from exactly parallel. Upon engagement between the male connector 312 and the female connector 314, the first clip 326 is biased into engagement with the second catch 332 and the second clip 330 is biased into engagement with the first catch 328 to secure the male connector 312 to the female connector 314.

The first clip 326 includes a first tapered protrusion 342 and a first biasing element 344. The first tapered protrusion 342 is secured to the first catch 328 via the first biasing element 344. The first tapered protrusion 342 has a first tapered surface 346 that terminates at a first edge surface 348. The second clip 330 includes a second tapered protrusion 350 and a second biasing element 352. The second tapered protrusion 350 is secured to the second catch 332 via the second biasing element 352. The second tapered protrusion 350 has a second tapered surface 354 that terminates at a second edge surface 356.

The second catch 332 includes a third tapered protrusion 358 having a third tapered surface 360 that terminates at a third edge surface 362. The first tapered surface 346 is configured to engage the third tapered surface 360 such that the first tapered protrusion 342 deflects via the first biasing element 344 about the first axis 338 during engagement between the male connector 312 and the female connector 314. The first edge surface 348 is configured to engage the third edge surface 362 upon full engagement between the male connector 312 and the female connector 314 to secure the position of the male connector 312 relative to the female connector 314 and to prevent disengagement of the male connector 312 from the female connector 314, particularly in the first direction 322.

The first catch 328 includes a fourth tapered protrusion 364 having a fourth tapered surface 366 that terminates at a fourth edge surface 368. The fourth tapered surface 366 is configured to engage the second tapered surface 354 such that the second tapered protrusion 350 deflects via the second biasing element 352 about the second axis 340 during engagement between the male connector 312 and the female connector 314. The second edge surface 356 is configured to engage the fourth edge surface 368 upon full engagement between the male connector 312 and the female connector 314 to secure the position of the male connector 312 relative to the female connector 314 and to prevent disengagement of the male connector 312 from the female connector 314, particularly in the first direction 322.

Disengagement between the male connector 312 and the female connector 314 may be accomplished via deflecting the first tapered protrusion 342 such that the first edge surface 348 disengages and clears the third edge surface 362 and via deflecting the second tapered protrusion 350 such that the second edge surface 356 disengages and clears the fourth edge surface 368. The first edge surface 348 clearing the third edge surface 362 may refer to a lack of interference between the first edge surface 348 and the third edge surface 362 in the first direction 322, and the second edge surface 356 clearing the fourth edge surface 368 may refer to a lack of interference between the second edge surface 356 and the fourth edge surface 368 in the first direction 322 such that the male connector 312 and the female connector 314 may be disengaged in the first direction 322. Deflection of the first tapered protrusion 342 and the second tapered protrusion 350 may be accomplished via inserting a tool (such as a flat head screw driver) between the first clip 326 and the second clip 330, followed by turning the tool so that it engages and deflects both the first tapered protrusion 342 and the second tapered protrusion 350 via the first biasing element 344 and second biasing element 352, respectively.

The female connector 314 includes a first backstop 370 that extends upward from the second frame 318 and laterally outward from the second frame 318. The first backstop 370 limits deflection of the first tapered protrusion 342 and the first biasing element 344 when the male connector 312 and the female connector 314 are engaged. More specifically, the first backstop 370 includes a tapered surface 372 that limits deflection of the first tapered protrusion 342 and the first biasing element 344 along the connection plane to prevent the first biasing element 344 from over-deflecting, which could result in plastic deformation or fracturing of the first biasing element 344. The first backstop 370 may also act as a shield or guard that protects the first clip 326, including the first tapered protrusion 342 and the first biasing element 344, from external forces or objects that could potentially cause damage to the first clip 326 when the male connector 312 and the female connector 314 are engaged.

The male connector 312 includes a second backstop 374 that extends upward from the first frame 316 and laterally outward from the first frame 316. The second backstop 374 limits deflection of the second tapered protrusion 350 and the second biasing element 352 when the male connector 312 and the female connector 314 are engaged. More specifically, the second backstop 374 includes a tapered surface 376 that limits deflection of the second tapered protrusion 350 and the second biasing element 352 along the connection plane to prevent the second biasing element 352 from over-deflecting, which could result in plastic deformation or fracturing of the second biasing element 352. The second backstop 374 may also act as a shield or guard that protects the second clip 330, including the second tapered protrusion 350 and the second biasing element 352, from external forces or objects that could potentially cause damage to the second clip 330 when the male connector 312 and the female connector 314 are engaged.

The male connector 312 (or more specifically the second backstop 374) defines a first keyed slot 378 and the female connector 314 includes a first keyed protrusion 380. The first keyed protrusion 380 is configured to engage the male connector 312 (or more specifically the second backstop 374) within the first keyed slot 378 to prevent movement between the male connector 312 and the female connector 314 in a direction (e.g., the second direction 334) that is transverse to a direction of engagement between the male connector 312 and the female connector 314 (e.g., the first direction 322). The engagement between the first keyed protrusion 380 and the male connector 312 within the first keyed slot 378 is also configured to absorb any shearing forces that may be experienced by the either the male connector 312 or the female connector 314.

In the fourth embodiment of the fastening system 300, the first keyed slot 378 is defined by the second backstop 374 and the first keyed protrusion 380 extends upward from the second frame 318. It should be understood, however, that the first keyed slot 378 and the first keyed protrusion 380 may be positioned at any location on the fastening system 300. Furthermore, it should be understood that the shapes of the first keyed protrusion 380 and the first keyed slot 378 depicted in FIGS. 7 and 8 should not be construed as limiting. The first keyed protrusion 380 and the first keyed slot 378 may have any shape as long the engagement between the first keyed protrusion 380 and the first keyed slot 378 is configured to absorb shearing forces and to prevent movement between the male connector 312 and the female connector 314 in a direction that is transverse to a direction of engagement between the male connector 312 and the female connector 314.

The female connector 314 (or more specifically the first backstop 370) defines a second keyed slot 382 and the male connector 312 includes a second keyed protrusion 384. The second keyed protrusion 384 is configured to engage the female connector 314 (or more specifically the first backstop 370) within the second keyed slot 382 to prevent movement between the male connector 312 and the female connector 314 in a direction (e.g., the second direction 334) that is transverse to a direction of engagement between the male connector 312 and the female connector 314 (e.g., the first direction 322). The engagement between the second keyed protrusion 384 and the female connector 314 within the second keyed slot 382 is also configured to absorb any shearing forces that may be experienced by the either the male connector 312 or the female connector 314.

In the fourth embodiment of the fastening system 300, the second keyed slot 382 is defined by the first backstop 370 and the second keyed protrusion 384 extends upward from the first frame 316. It should be understood, however, that the second keyed slot 382 and the second keyed protrusion 384 may be positioned at any location on the fastening system 300. Furthermore, it should be understood that the shapes of the second keyed protrusion 384 and the second keyed slot 382 depicted in FIGS. 7 and 8 should not be construed as limiting. The second keyed protrusion 384 and the second keyed slot 382 may have any shape as long the engagement between the second keyed protrusion 384 and the second keyed slot 382 is configured to absorb shearing forces and to prevent movement between the male connector 312 and the female connector 314 in a direction that is transverse to a direction of engagement between the male connector 312 and the female connector 314.

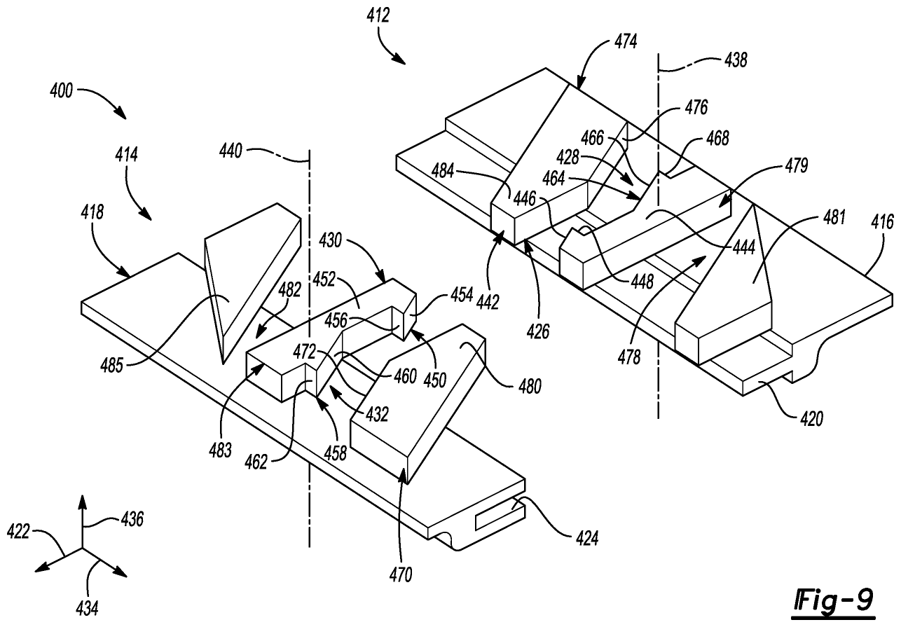

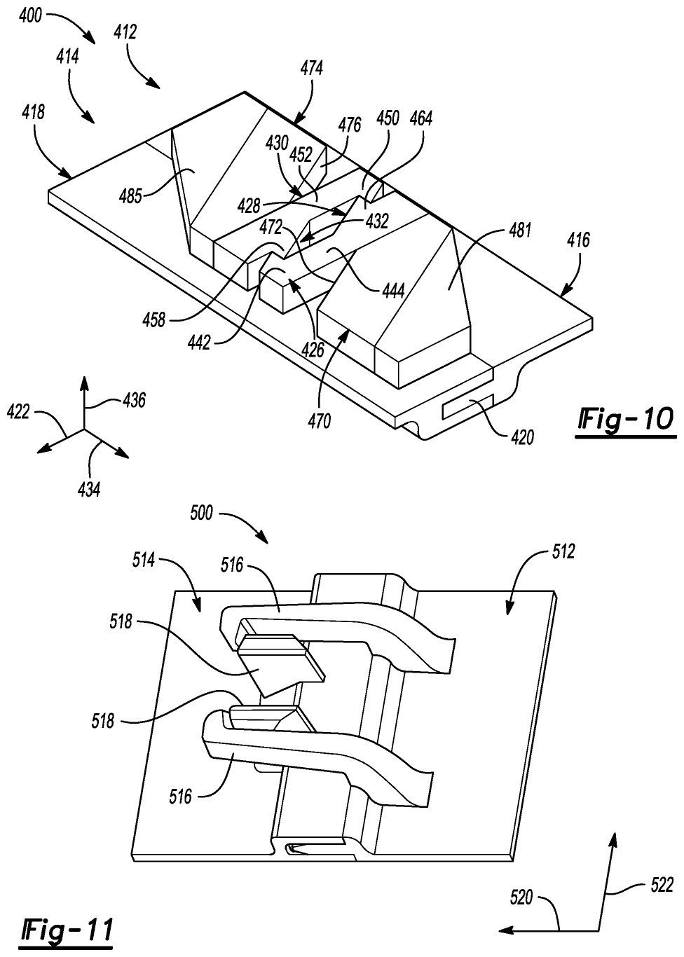

Referring to FIGS. 9 and 10, a fifth embodiment of a fastening system 400 is illustrated. The fastening system 400 includes a male connector 412 and a female connector 414. The male connector 412 and the female connector 414 may be referred to as the first and second connectors, respectively, or vice versa. The male connector 412 includes a first frame 416 and the female connector 414 includes a second frame 418. The male connector 412 includes a protrusion or guide pin 420 that extends in a first direction 422. More specifically, the protrusion or guide pin 420 may extend from the first frame 416 in the first direction 422. The female connector 414 defines a slot 424 that also extends in the first direction 422. More specifically, the second frame 418 defines the slot 424. The slot 424 is configured to receive the guide pin 420 upon engagement between the male connector 412 and the female connector 414 in the first direction 422.

The male connector 412 includes a first clip 426 and a first catch 428. The female connector 414 includes a second clip 430 and a second catch 432. The first direction 422 and a second direction 434 that is transverse to the first direction 422 form a connection plane. The first direction 422 and the second direction 434 may be substantially perpendicular relative to each other. Substantially perpendicular may refer to any incremental value that ranges between 80° and 100°. The connection plane is the plane upon which the male connector 412 engages the female connector 414. The first clip 426 and the first catch 428 are offset from the guide pin 420 in a third direction 436. The third direction 436 may be substantially perpendicular to the first direction 422, the second direction 434, and the connection plane. Substantially perpendicular may refer to any incremental value that ranges between 80° and 100°. The second clip 430 and the second catch 432 are offset from the slot 424 in the third direction 436.

The first clip 426 and the first catch 428 extend upward from the first frame 416. The first clip 426 also extends laterally outward from the first frame 416. Extending laterally outward from the first frame 416 may refer to extending outward from the first frame 416 in any direction defined on the connection plane. However, extending laterally outward from the first frame 416 may specifically refer to extending outward from the first frame 416 in the first direction 422. The second clip 430 and the second catch 432 extend upward from second frame 418. The second clip 430 also extends laterally outward from the second frame 418. Extending laterally outward from the second frame 418 may refer to extending outward from the second frame 418 in any direction defined on the connection plane. However, extending laterally outward from the second frame 418 may specifically refer to extending outward from the second frame 418 in the first direction 422.

The first clip 426 is biased radially relative to a first axis 438 that is substantially parallel to the third direction 436 and substantially perpendicular to the connection plane. Substantially perpendicular may refer to any incremental value that ranges between 80° and 100° and substantially parallel may refer to any incremental value that ranges between exactly parallel and 10° from exactly parallel. The first clip 426 is configured to deflect and rotate about the first axis 438 along a plane that is substantially parallel to the connection plane during engagement between the male connector 412 and the female connector 414. Substantially parallel may refer to any incremental value that ranges between exactly parallel and 10° from exactly parallel. The second clip 430 is biased radially relative to a second axis 440 that is substantially parallel to the third direction 436 and substantially perpendicular to the connection plane. Substantially perpendicular may refer to any incremental value that ranges between 80° and 100° and substantially parallel may refer to any incremental value that ranges between exactly parallel and 10° from exactly parallel. The second clip 430 is configured to deflect and rotate about the second axis 440 along a plane that is substantially parallel to the connection plane during engagement between the male connector 412 and the female connector 414. Substantially parallel may refer that any incremental value that ranges between exactly parallel and 10° from exactly parallel. Upon engagement between the male connector 412 and the female connector 414, the first clip 426 is biased into engagement with the second catch 432 and the second clip 430 is biased into engagement with the first catch 428 to secure the male connector 412 to the female connector 414.

The first clip 426 includes a first tapered protrusion 442 and a first biasing element 444. The first tapered protrusion 442 is secured to the first catch 428 via the first biasing element 444. The first tapered protrusion 442 has a first tapered surface 446 that terminates at a first edge surface 448. The second clip 430 includes a second tapered protrusion 450 and a second biasing element 452. The second tapered protrusion 450 is secured to the second catch 432 via the second biasing element 452. The second tapered protrusion 450 has a second tapered surface 454 that terminates at a second edge surface 456.

The second catch 432 includes a third tapered protrusion 458 having a third tapered surface 460 that terminates at a third edge surface 462. The first tapered surface 446 is configured to engage the third tapered surface 460 such that the first tapered protrusion 442 deflects via the first biasing element 444 about the first axis 438 during engagement between the male connector 412 and the female connector 414. The first edge surface 448 is configured to engage the third edge surface 462 upon full engagement between the male connector 412 and the female connector 414 to secure the position of the male connector 412 relative to the female connector 414 and to prevent disengagement of the male connector 412 from the female connector 414, particularly in the first direction 422.

The first catch 428 includes a fourth tapered protrusion 464 having a fourth tapered surface 466 that terminates at a fourth edge surface 468. The fourth tapered surface 466 is configured to engage the second tapered surface 454 such that the second tapered protrusion 450 deflects via the second biasing element 452 about the second axis 440 during engagement between the male connector 412 and the female connector 414. The second edge surface 456 is configured to engage the fourth edge surface 468 upon full engagement between the male connector 412 and the female connector 414 to secure the position of the male connector 412 relative to the female connector 414 and to prevent disengagement of the male connector 412 from the female connector 414, particularly in the first direction 422.

Disengagement between the male connector 412 and the female connector 414 may be accomplished via deflecting the first tapered protrusion 442 such that the first edge surface 448 disengages and clears the third edge surface 462 and via deflecting the second tapered protrusion 450 such that the second edge surface 456 disengages and clears the fourth edge surface 468. The first edge surface 448 clearing the third edge surface 462 may refer to a lack of interference between the first edge surface 448 and the third edge surface 462 in the first direction 422, and the second edge surface 456 clearing the fourth edge surface 468 may refer to a lack of interference between the second edge surface 456 and the fourth edge surface 468 in the first direction 422 such that the male connector 412 and the female connector 414 may be disengaged in the first direction 422. Deflection of the first tapered protrusion 442 and the second tapered protrusion 450 may be accomplished via inserting a tool (such as a flat head screw driver) between the first clip 426 and the second clip 430, followed by turning the tool so that it engages and deflects both the first tapered protrusion 442 and the second tapered protrusion 450 via the first biasing element 444 and second biasing element 452, respectively.

The female connector 414 includes a first backstop 470 that extends upward from the second frame 418 and laterally outward from the second frame 418. The first backstop 470 limits deflection of the first tapered protrusion 442 and the first biasing element 444 when the male connector 412 and the female connector 414 are engaged. More specifically, the first backstop 470 includes a tapered surface 472 that limits deflection of the first tapered protrusion 442 and the first biasing element 444 along the connection plane to prevent the first biasing element 444 from over-deflecting, which could result in plastic deformation or fracturing of the first biasing element 444. The first backstop 470 may also act as a shield or guard that protects the first clip 426, including the first tapered protrusion 442 and the first biasing element 444, from external forces or objects that could potentially cause damage to the first clip 426 when the male connector 412 and the female connector 414 are engaged.

The male connector 412 includes a second backstop 474 that extends upward from the first frame 416 and laterally outward from the first frame 416. The second backstop 474 limits deflection of the second tapered protrusion 450 and the second biasing element 452 when the male connector 412 and the female connector 414 are engaged. More specifically, the second backstop 474 includes a tapered surface 476 that limits deflection of the second tapered protrusion 450 and the second biasing element 452 along the connection plane to prevent the second biasing element 452 from over-deflecting, which could result in plastic deformation or fracturing of the second biasing element 452. The second backstop 474 may also act as a shield or guard that protects the second clip 430, including the second tapered protrusion 450 and the second biasing element 452, from external forces or objects that could potentially cause damage to the second clip 430 when the male connector 412 and the female connector 414 are engaged.

The male connector 412 defines a first keyed slot 478 and the female connector 414 includes a first keyed protrusion 480. The first keyed slot 478 is defined between a first component 479 that forms both the first clip 426 and the first catch 428 and a second component 481 that extends upward from the first frame 416 and laterally outward from the first frame 416. The first keyed protrusion 480 is configured to engage the male connector 412 (or more specifically the first component 479 and the second component 481) within the first keyed slot 478 to prevent movement between the male connector 412 and the female connector 414 in a direction (e.g., the second direction 434) that is transverse to a direction of engagement between the male connector 412 and the female connector 414 (e.g., the first direction 422). The engagement between the first keyed protrusion 480 and the male connector 412 within the first keyed slot 478 is also configured to absorb any shearing forces that may be experienced by the either the male connector 412 or the female connector 414.

In the fifth embodiment of the fastening system 400, the first keyed slot 478 is defined by the first and second components 479, 481 and the first keyed protrusion 480 extends upward from the second frame 418. It should be understood, however, that the first keyed slot 478 and the first keyed protrusion 480 may be positioned at any location on the fastening system 400. Furthermore, it should be understood that the shapes of the first keyed protrusion 480 and the first keyed slot 478 depicted in FIGS. 9 and 10 should not be construed as limiting. The first keyed protrusion 480 and the first keyed slot 478 may have any shape as long the engagement between the first keyed protrusion 480 and the first keyed slot 478 is configured to absorb shearing forces and to prevent movement between the male connector 412 and the female connector 414 in a direction that is transverse to a direction of engagement between the male connector 412 and the female connector 414.

The female connector 414 defines a second keyed slot 482 and the male connector 412 includes a second keyed protrusion 484. The second keyed slot 482 is defined between a first component 483 that forms both the second clip 430 and the second catch 432 and a second component 485 that extends upward from the second frame 418 and laterally outward from the second frame 418. The second keyed protrusion 484 is configured to engage the female connector 414 (or more specifically the first component 483 and the second component 485) within the second keyed slot 482 to prevent movement between the male connector 412 and the female connector 414 in a direction (e.g., the second direction 434) that is transverse to a direction of engagement between the male connector 412 and the female connector 414 (e.g., the first direction 422). The engagement between the second keyed protrusion 484 and the female connector 414 within the second keyed slot 482 is also configured to absorb any shearing forces that may be experienced by the either the male connector 412 or the female connector 414.

In the fifth embodiment of the fastening system 400, the second keyed slot 482 is defined by the first and second components 483, 485 and the second keyed protrusion 484 extends upward from the first frame 416. It should be understood, however, that the second keyed slot 482 and the second keyed protrusion 484 may be positioned at any location on the fastening system 400. Furthermore, it should be understood that the shapes of the second keyed protrusion 484 and the second keyed slot 482 depicted in FIGS. 9 and 10 should not be construed as limiting. The second keyed protrusion 484 and the second keyed slot 482 may have any shape as long the engagement between the second keyed protrusion 484 and the second keyed slot 482 is configured to absorb shearing forces and to prevent movement between the male connector 412 and the female connector 414 in a direction that is transverse to a direction of engagement between the male connector 412 and the female connector 414.

Referring to FIG. 11, sixth embodiment of a fastening system 500 is illustrated. The fastening system 500 includes the same components and functionality as fastening system 100 unless otherwise described herein. The fastening system 500 includes a male connector 512 and a female connector 514. The male connector 512 includes two inward facing clips 516 that protrude upward and laterally from the male connector 512. The two inward facing clips 516 engage one or more catches 518 that protrude upward from the female connector 514. Alternatively, the two inward facing clips 516 may protrude upward from the female connector 514 while the one or more catches 518 may protrude upward from the male connector 512. Engagement between the two inward facing clips 516 and the one or more catches 518 prevents disengagement of the male connector 512 and the female connector 514 in an engagement direction 520. Also, the positioning of the one or more catches 518 between the two inward facing clips 516 will prevent relative movement between the male connector 512 and the female connector 514 in a direction 522 that is transverse to the engagement direction 520.

The fastening systems described herein may secured to or may be integral parts of subcomponents of a system or device where the subcomponents are connected to each other via the one of the fastening systems. For example, a male connector of one of the fastening systems may be integral to a first component while the female connector may be integral to a second component that is connectable to the first component via engagement between the male connector and the female connector. The fastening systems described herein may specifically be utilized to secure vehicle heating, ventilation, and air conditioning (HVAC) components to each other.

It should be understood that the designations of first, second, third, fourth, etc. for directions, axes, frames, clips, catches, backstops, biasing elements, tapered surfaces, edge surfaces, tapered protrusion, keyed slots, keyed protrusions, or any other component, state, or condition described herein may be rearranged in the claims so that they are in chronological order with respect to the claims.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A fastening system comprising:
a male connector having a guide pin, a first clip, and a first catch, wherein
the guide pin extends in a first direction,
the first clip and the first catch are offset from the guide pin in a second direction that is substantially perpendicular to the first direction, and
the first clip is biased radially relative to a first axis that is substantially parallel to the second direction; and
a female connector defining a slot, having a second clip, and having a second catch, wherein
the slot extends in the first direction,
the second clip and the second catch are offset from the slot in the second direction, and
the second clip is biased radially relative to a second axis that is substantially parallel to the second direction, and
wherein the slot is configured to receive the guide pin upon engagement between the male connector and the female connector in the first direction, and wherein the first clip is biased into engagement with the second catch and the second clip is biased into engagement with the first catch to secure the male connector to the female connector.

2. The fastening system of claim 1, wherein the first clip includes a first tapered protrusion and a first biasing element, the first tapered protrusion being secured to the first catch via the first biasing element, and the first tapered protrusion having a first tapered surface that terminates at a first edge surface.

3. The fastening system of claim 2, wherein the male connector includes a backstop that limits deflection of the first tapered protrusion and the first biasing element.

4. The fastening system of claim 2, wherein the second catch includes a second tapered protrusion having a second tapered surface that terminates at a second edge surface, wherein the first tapered surface is configured to engage the second tapered surface such that the first tapered protrusion deflects via the first biasing element, and wherein the first edge surface is configured to engage the second edge surface upon full engagement between the male and female connectors to secure the position of the male connector relative to the female connector and to prevent disengagement of the male connector from the female connector.

5. The fastening system of claim 4, wherein the second clip includes a third tapered protrusion and a second biasing element, the third tapered protrusion being secured to the second catch via the second biasing element, and the third tapered protrusion having a third tapered surface that terminates at a third edge surface.

6. The fastening system of claim 5, wherein the female connector includes a backstop that limits deflection of the third tapered protrusion and the second biasing element.

7. The fastening system of claim 5, wherein the first catch includes a fourth tapered protrusion having a fourth tapered surface that terminates at a fourth edge surface, wherein the fourth tapered surface is configured to engage the third tapered surface such that the third tapered protrusion deflects via the second biasing element, and wherein the third edge surface is configured to engage the fourth edge surface upon full engagement between the male and female connectors to secure the position of the male connector relative to the female connector and to prevent disengagement of the male connector from the female connector.

8. The fastening system of claim 1, wherein the male connector defines a keyed slot and the female connector includes a keyed protrusion that is configured to engage the male connector within the keyed slot to prevent movement between the male and female connectors in direction that is transverse to the first direction.

9. The fastening system of claim 1, wherein the female connector defines a keyed slot and the male connector includes a keyed protrusion that is configured to engage the female within the keyed slot to prevent movement between the male and female connectors in direction that is transverse to the first direction.

10. A fastening system comprising:
a first connector having a protrusion, a first clip, and a first catch, wherein the first clip and the first catch are offset from the protrusion; and
a second connector defining a slot, having a second clip, and having a second catch, wherein the second clip and the second catch are offset from the slot, and wherein the slot is configured to receive the protrusion upon engagement between the first connector and the second connector, and wherein the first clip is biased into engagement with the second catch and the second clip is biased into engagement with the first catch upon engagement between the first connector and the second connector to secure the first connector to the second connector.

11. The fastening system of claim 10, wherein the first clip includes a first tapered protrusion and a first biasing element, the first tapered protrusion being secured to the first catch via the first biasing element, and the first tapered protrusion having a first tapered surface that terminates at a first edge surface.

12. The fastening system of claim 11, wherein the second catch includes a second tapered protrusion having a second tapered surface that terminates at a second edge surface, wherein the first tapered surface is configured to engage the second tapered surface such that the first tapered protrusion deflects via the first biasing element, and wherein the first edge surface is configured to engage the second edge surface upon full engagement between the first and second connectors to secure the position of the first connector relative to the second connector and to prevent disengagement of the first connector from the second connector.

13. The fastening system of claim 12, wherein the second clip includes a third tapered protrusion and a second biasing element, the third tapered protrusion being secured to the second catch via the second biasing element, and the third tapered protrusion having a third tapered surface that terminates at a third edge surface.

14. The fastening system of claim 13, wherein the first catch includes a fourth tapered protrusion having a fourth tapered surface that terminates at a fourth edge surface, wherein the fourth tapered surface is configured to engage the third tapered surface such that the third tapered protrusion deflects via the second biasing element, and wherein the third edge surface is configured to engage the fourth edge surface upon full engagement between the first and second connectors to secure the position of the first connector relative to the second connector and to prevent disengagement of the first connector from the second connector.

15. The fastening system of claim 14, wherein one of the first connector and the second connector defines a keyed slot and the other of the first connector and the second connector includes a keyed protrusion that is configured to engage the keyed slot to prevent movement between the first and second connectors in direction that is transverse to the a direction of engagement between the protrusion and the slot.

16. A fastening system comprising:
a male connector having a first frame, a guide pin extending from the first frame, a first clip extending laterally from the first frame, and a first catch extending upward from the first frame, wherein the first clip and the first catch are offset from the guide pin; and
a female connector having a second frame defining a slot, having a second clip extending laterally from the second frame, and having a second catch extending upward from the second frame, wherein the second clip and the second catch are offset from the slot, and wherein the slot is configured to receive the guide pin upon engagement between the male connector and the female connector, and wherein the first clip is biased into engagement with the second catch and the second clip is biased into engagement with the first catch upon engagement between the male connector and the female connector to secure the male connector to the female connector.

17. The fastening system of claim 16, wherein the first clip includes a first tapered protrusion and a first biasing element, the first tapered protrusion being secured to the first catch via the first biasing element, and the first tapered protrusion having a first tapered surface that terminates at a first edge surface.

18. The fastening system of claim 17, wherein the second catch includes a second tapered protrusion having a second tapered surface that terminates at a second edge surface, wherein the first tapered surface is configured to engage the second tapered surface such that the first tapered protrusion deflects via the first biasing element, and wherein the first edge surface is configured to engage the second edge surface upon full engagement between the male and female connectors to secure the position of the male connector relative to the female connector and to prevent disengagement of the male connector from the female connector.

19. The fastening system of claim 18, wherein the second clip includes a third tapered protrusion and a second biasing element, the third tapered protrusion being secured to the second catch via the second biasing element, and the third tapered protrusion having a third tapered surface that terminates at a third edge surface.

20. The fastening system of claim 19, wherein the first catch includes a fourth tapered protrusion having a fourth tapered surface that terminates at a fourth edge surface, wherein the fourth tapered surface is configured to engage the third tapered surface such that the third tapered protrusion deflects via the second biasing element, and wherein the third edge surface is configured to engage the fourth edge surface upon full engagement between the male and female connectors to secure the position of the male connector relative to the female connector and to prevent disengagement of the male connector from the female connector.
